(19) United States
(12) Patent Application Publication
(10) Pub. No.: US 2006/0187774 A1
(43) Pub. Date: Aug. 24, 2006

(54) Recording apparatus, reproduction apparatus, and control method

(75) Inventors: Yoshihiro Koizumi, Kanagawa (JP); Atsuo Okamoto, Kanagawa (JP); Tsuyoshi Harata, Kanagawa (JP); Masahiro Shimizu, Tokyo (JP); Ryuji Yano, Tokyo (JP); Hideki Mawatari, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/341,451

(22) Filed: Jan. 30, 2006

(30) Foreign Application Priority Data
Feb. 22, 2005 (JP) 2005-046170

(51) Int. Cl. G11B 7/00

(52) U.S. Cl. 369/44.27; 369/53.25

(57) ABSTRACT

A recording apparatus includes: recording means having a drive part including rotational drive means for rotating an optical recording medium in order to record data onto the optical recording medium; data coding means for coding data; and recording control means for storing the coded data into storage means and controlling the recording means to record the data stored in the storage means onto the optical recording medium. The recording control means includes overall control means for controlling the recording control means overall and servo control means for servo-controlling the drive part of the recording means. In the recording-standby state standing by to store the coded data, the overall control means stops operation of the servo control means, and at the same time, servo-controls the rotational drive means.

### CROSS REFERENCES TO RELATED APPLICATIONS

The present invention contains subject matter related to Japanese Patent Application JP 2005-046170 filed in the Japanese Patent Office on Feb. 22, 2005, the entire contents of which are incorporated herein by reference.

### BACKGROUND OF THE INVENTION

1. Field of the Invention

The present invention relates to a recording apparatus for recording compressed data onto an optical recording medium, a method of controlling the recording apparatus, a reproduction apparatus for reading compressed data recorded on an optical recording medium, and a method of controlling the reproduction apparatus.

2. Description of the Related Art

Among known AV (Audio-Video) apparatuses, there are AV apparatuses for performing compression processing, for example using MPEG (Moving Picture Expert Group), on input audio-video data to record the compressed audio-video data onto an optical recording medium such as a DVD, etc. In such an AV apparatus, a recording method called intermittent recording is used in order to match the timings of the time necessary for compression processing and the time necessary for recording processing. The intermittent recording is a recording method in which a “recording” state and a “recording-standby” state are repeated alternately. That is to say, the compression of the audio-video data is waited in the “recording-standby” state, and the compressed audio-video data is recorded onto the optical recording medium in the “recording” state.

A general procedure of the intermittent recording is described below by taking a digital camera as an example. In a digital camera, (1) audio-video data converted into electronic signals by an imager such as CCDs (Charge Coupled Devices) and a microphone is input. (2) The audio-video data is subjected to compression processing using MPEG, etc., and is temporarily stored into a memory. (3) When a certain amount of the audio-video data is stored, the data stored in the memory is read in accordance with the recording speed of the optical recording medium to be recorded onto the optical recording medium. (4) When the recording of the audio-video data stored in the memory is completed, the processing is waited until the audio-video data is stored in the memory once again. The sequence from (1) to (4) is repeated in the recording processing of the digital camera.

The processing of (1) and (2) are operated in real time for the audio-video data to be captured. In the recording processing of (4), the bit rate is higher than that of the compression processing of (3), and thus standby time is necessary for the processing of (3). Accordingly, in the data recording of an optical recording medium, intermittent recording, in which a “recording” state and a “recording-standby” state are repeated alternately, is performed.

In the “recording” state of (3), a recording-reproduction system such as a laser emitting part, a reflection-light receiving part, etc., and a servo system such as a tracking servo, a thread servo, etc., are activated. In the “recording-standby” state of (4), electric power consumed in the recording-reproduction system and the servo system is wasteful, and thus it is desirable to reduce the electric power consumed at this time as little as possible. Accordingly, in the “recording-standby” state, the recording-reproduction system and the servo system are set to a power-saving state.

When the spindle servo for controlling the rotational speed of a disc is set to a power-saving state, it becomes difficult to maintain an appropriate rotational speed. When the rotational speed changes, problems arises in that (1) the sound of the spindle motor is generated, and is recorded in the audio data as noise even by a slight change of the speed, (2) it takes time until the disc attains an appropriate speed at the next “recording”, and the standby time becomes short as a result, and thus the power-saving effect becomes little, and (3) in case that the rotation stops, it becomes necessary to have a large current at starting time, and thus an adverse effect to the power saving is produced.

In a known technique, in order to handle these problems, first, a target voltage is determined by measuring a drive voltage applied to the spindle motor at the time when servo control is performed during recording or during reproduction. Thereafter, the determined target voltage is given to the spindle motor as an alternative voltage, and thus an appropriate rotational speed is maintained (for example, Japanese Unexamined Patent Application Publication No. 2002-93032).

### SUMMARY OF THE INVENTION

However, known spindle control is performed by open loop control. Thus, when some factor that causes the alternative voltage to change during the “recording-standby” or immediately before the “recording-standby” arises, there is no feedback capability against this change. Accordingly, it sometimes becomes difficult to maintain an appropriate rotational speed. The factors that cause the alternative voltage to change include, for example, the change of load on the spindle by vibration, impact, force of inertia, etc., applied to the camcorder. Although, a description has been given of the intermittent recording, the same description will be given of the intermittent reproduction.

The present invention has been made in view of the above-described problems. It is desirable to provide a recording apparatus which maintains a state suitable for starting the recording operation at recording standby time of an optical recording medium and a control method of the recording apparatus. Also, it is desirable to provide a reproduction apparatus which maintains a suitable state for starting a reading operation at reading standby time of the optical recording medium and a control method of the reproduction apparatus.

According to an embodiment of the present invention, there is provided a recording apparatus including: recording means having a drive part including rotational drive means for rotating an optical recording medium in order to record data onto the optical recording medium; data coding means for coding data; and recording control means for storing the coded data into storage means, and controlling the recording means to record the data stored in the storage means onto the optical recording medium, wherein the recording control means includes overall control means for controlling the recording control means overall and servo control means for servo-controlling the drive part of the recording means, and in a recording-standby state standing by to store the coded data, the overall control means stops operation of the servo control means, and at the same time, servo-controls the rotational drive means.

According to an embodiment of the present invention, there is provided a method of controlling a recording apparatus having a drive part including rotational drive means for rotating an optical recording medium in order to record data onto the optical recording medium, the method including the steps of: coding data; controlling the rotational drive means for storing by overall control means controlling the recording apparatus overall in a recording-standby state to store the coded data; and servo-controlling the drive part by servo control means for drive-controlling the recording apparatus to record the coded data onto the optical recording medium when storing the coded data is completed.

According to an embodiment of the present invention, there is provided a reproduction apparatus including: reading means having a drive part including rotational drive means for rotating an optical recording medium in order to read coded data recorded in the optical recording medium; read control means for controlling the reading means; storing means for storing the read coded data; and decoding means for decoding the stored coded data, wherein the read control means includes overall control means for controlling the read control means overall and servo control means for servo-controlling the drive part of the reading means, and in a reading-standby state standing by to decode the coded data stored in the storing means, the overall control means stops operation of the servo control means, and at the same time, controls the rotational drive means.

According to an embodiment of the present invention, there is provided a method of controlling a reproduction apparatus having a drive part including rotational drive means for rotating an optical recording medium in order to read coded data recorded onto the optical recording medium, the method including the steps of: reading coded data recorded in the optical recording medium of the reproduction apparatus; storing the read coded data into the storing means; and controlling the rotational drive of the optical recording medium by overall control means controlling the reproduction apparatus overall in a reading-standby state standing by to decode the coded data stored in the storing means.

In a recording apparatus to which the present invention is applied, the operation of the servo control means is stopped in the “recording-standby” state in which the storing of the coded data is stood by, and the servo control of the rotational drive means is alternated with the overall control means. Thus, it is possible to reduce the power consumption necessary for the servo control of the entire drive part, and to continue the servo control of the rotational drive means in order to maintain the rotational drive means at a suitable state for starting the recording operation.

In a reproduction apparatus to which the present invention is applied, the operation of the servo control means is stopped in a “reading-standby” state in which the decoding of the coded data stored in the storing means is stood by, and the servo control of the rotational drive means is alternated with the overall control means. Thus, it is possible to reduce the power consumption necessary for the servo control of the entire drive part, and to continue the servo control of the rotational drive means in order to maintain the rotational drive means at a suitable state for starting the reading operation.

### BRIEF DESCRIPTION OF THE DRAWINGS

FIG. 1 is a block diagram illustrating the configuration of a recording-reproduction apparatus;

FIG. 2 is a block diagram illustrating the configuration of an AV interface;

FIG. 3 is a block diagram illustrating an audio-video data flow in intermittent recording;

FIG. 4 is a block diagram illustrating the configuration of a drive controller and a disc drive;

FIG. 5 is a flowchart illustrating the operation of the recording-reproduction apparatus;

FIG. 6 is a flowchart illustrating the operation of a microcomputer and a DSP when the processing moves from a “recording operation” state to a “wait recording” state; and

FIG. 7 is a flowchart illustrating the operation of a microcomputer and a DSP when the processing moves from the “wait recording” state to the “recording operation” state.

### DESCRIPTION OF THE PREFERRED EMBODIMENTS

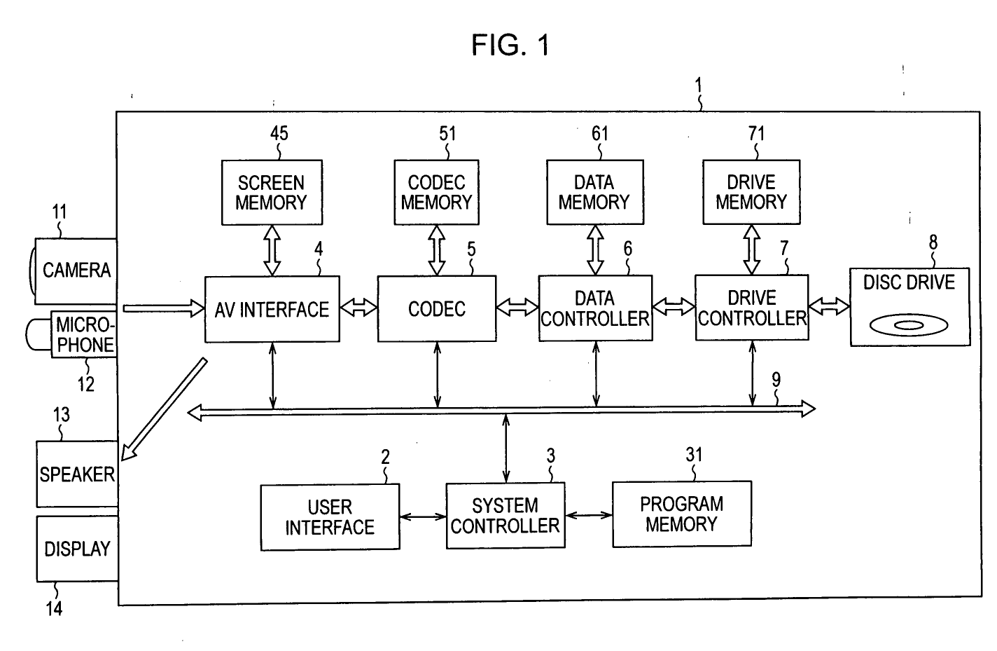

In the following, a description will be given of a recording-reproduction apparatus 1 to which the present invention is applied with reference to the drawings. FIG. 1 shows the configuration of the recording-reproduction apparatus 1. The recording-reproduction apparatus 1 includes a user interface 2 for receiving a user's input and informing the user of the state of the apparatus, a system controller 3 for controlling the entire apparatus, an AV (audio-video) interface 4 for relaying an input/output device such as a camera 11, an unillustrated display, etc., and the recording-reproduction apparatus 1, a CODEC 5 for compressing and expanding audio-video data, a data controller 6 for controlling data flow, a disc drive 8 for recording and reproducing to and from an optical recording medium, a drive controller 7 for controlling the disc drive 8, a display 14 for outputting video data, and a speaker 13 for outputting an audio signal.

The user interface 2 receives input from the user through an input part, such as a key-input button, a switch 75, etc., and informs the user of the state of the apparatus through an output part, such as a light emitting element, an acoustic element, etc.

The system controller 3 loads a system control program and a file system into a program memory 31 as a working memory, and outputs control signals to each block of the recording-reproduction apparatus 1. The system controller 3 uses a system control bus 9 for the transmission of the control signals.

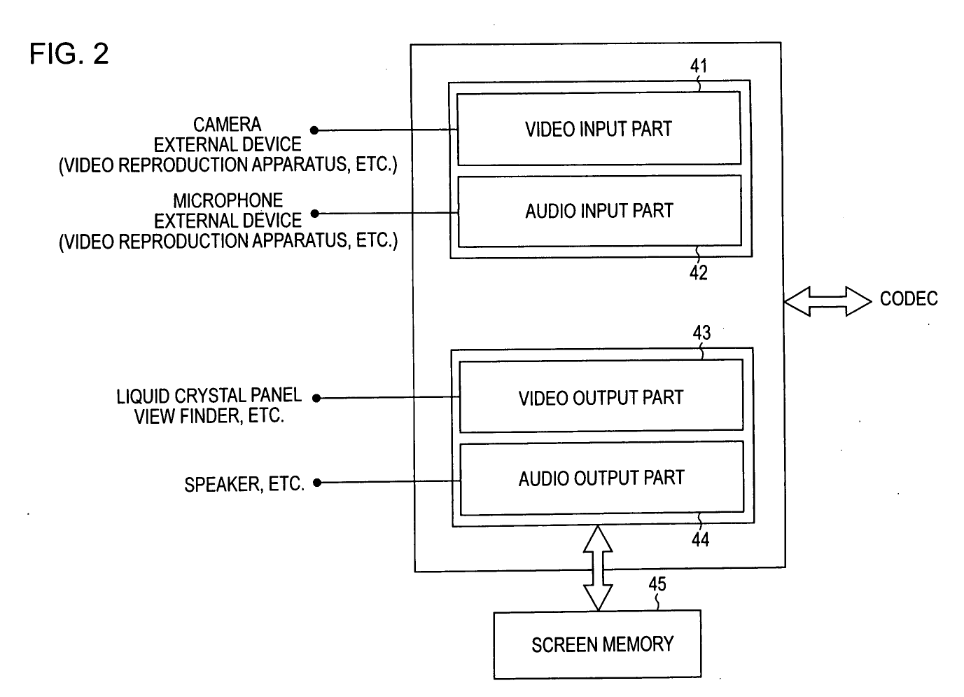

As shown in FIG. 2, the AV interface 4 includes a video input part 41, an audio input part 42, a video output part 43, and an audio output part 44. The video input part 41 receives input of video data from the camera 11, an external device, etc., and the audio input part 42 receives input of sound from the microphone 12, an external device, etc. The video output part 43 outputs video data to a liquid crystal panel, a view finder, etc., and the audio output part 44 outputs an audio signal to the speaker 13, etc. The AV interface 4 outputs the video data captured by the camera 11 and the audio signal obtained by the microphone 12 to the view finder and the speaker 13 in real time. When an image is output to the view finder, the AV interface 4 superimposes a screen image on the output image. The screen image is stored in a screen memory 45. Characters and icons are drawn on the screen image.

Next, a description will be given of the CODEC 5, the data controller 6, the drive controller 7 at data recording time. The AV interface 4 outputs the audio-video data obtained from the camera 11 and the microphone 12 to the CODEC 5. The CODEC 5 compresses the input audio-video data. Here, MPEG (Moving Picture Expert Group) is used as a compression method of the audio-video data. A CODEC memory 51 is a work area of the CODEC 5. The CODEC memory 51 stores differential signal compression between frames or fields of the video data.

The data controller 6 controls the data flow between the CODEC 5 and the drive controller 7. The data controller 6 and the drive controller 7 transmit and receive audio-video data in accordance with a discontinuous handshake protocol. In this protocol, the data controller 6 stores the data input from the CODEC 5 into a data memory 61, and transfers the data stored in the data memory 61 to the drive controller 7 when a certain amount of the data is stored in the data memory 61.

The data controller 6 transfers the data to the drive controller 7, and determines the state transition between the “recording” state and the “recording-standby” state of the drive controller 7. The drive controller 7 writes the audio-video data stored in the drive memory 71 onto the optical recording medium in response to the instruction from the data controller 6.

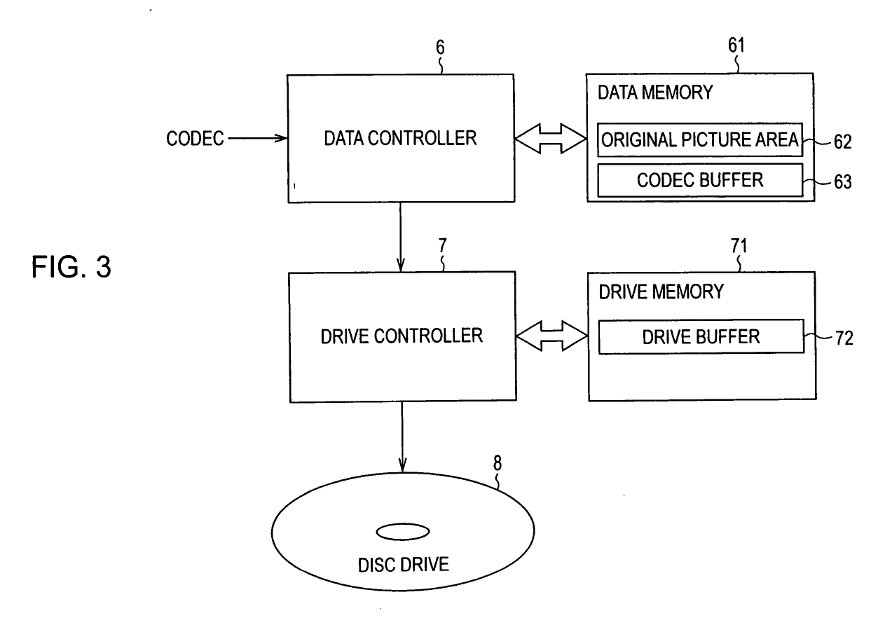

The drive controller 7 repeats the “recording-standby” state in which data from the data controller 6 is waited and the “recording” state in which data is written into the optical recording medium. Such a recording method is called intermittent recording. A description will be given of the intermittent recording using FIG. 3. The audio-video data compressed by the CODEC 5 is output to the data controller 6. The video data transmitted to the data controller 6 is temporarily stored in an original picture area 62 in the data memory 61 contained in the data controller 6. The CODEC 5 performs MPEG compression on the video data stored in the original picture area 62, and stored the data into a CODEC buffer 63. The CODEC 5 stores the compressed audio-video data into the buffer area for each compression of the audio-video data. When the data stored in the CODEC buffer 63 reaches a certain size, the data controller 6 transfers the audio-video data stored in the CODEC buffer 63 to the drive controller 7. The transfer rate at this time is sufficiently higher than the storage speed of the audio-video data into the CODEC buffer 63.

The drive controller 7 stores the audio-video data output from the data controller 6 into a drive buffer 72 of the drive memory 71. The drive controller 7 controls the disc drive 8 to record the audio-video data stored in the drive buffer 72 onto an optical recording medium. The recording speed at this time is sufficiently higher than the storage speed of the audio-video data into the CODEC buffer 63. Thereafter, the compression processing of the audio-video data and the recording processing of the compressed audio-video data are repeated until the completion of the recording. During this period, the “recording” state onto the optical recording medium and the “recording-standby” state of waiting the storage of the audio-video data are repeated alternately.

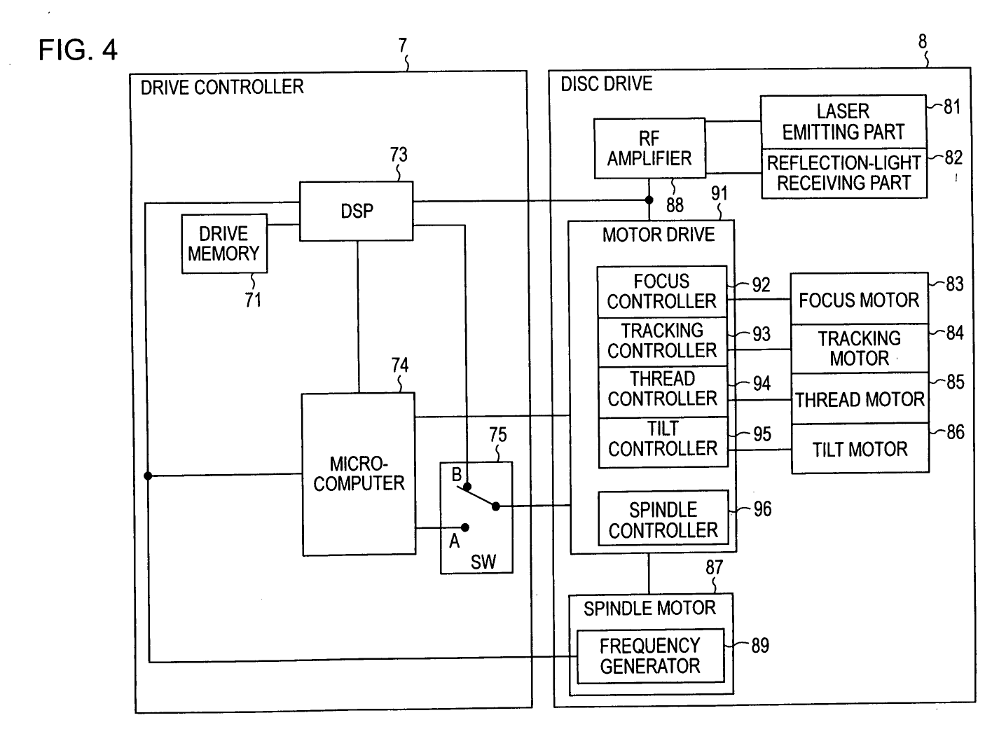

As shown in FIG. 4, the drive controller 7 includes a drive memory 71, a DSP 73, a microcomputer 74, and a switch 75. The DSP 73 controls the recording operation of the disc drive 8.

The disc drive 8 includes a laser emitting part 81 for emitting laser onto the optical recording medium, a reflection-light receiving part 82 for receiving reflection light from an optical recording medium, a focus motor 83 for adjusting a focal depth of the lens, a tracking motor 84 for causing the laser to follow the tracks, a thread motor 85 for moving the pickup in the diametrical direction of a disc, a tilt motor 86 for adjusting the tilt of the lens, a spindle motor 87 for rotating the disc, and a motor drive 91 for driving each motor. The motor drive 91 includes a focus controller 92 for controlling the focus motor 83, a tracking controller 93 for controlling the tracking motor 84, a thread controller 94 for controlling the thread motor 85, a tilt controller 95 for controlling the tilt motor 86, and a spindle controller 96 for controlling the spindle motor 87.

The DSP 73 performs closed-loop control on the laser emitting part 81, the focus controller 92, the tracking controller 93, the thread controller 94, the tilt controller 95, and the spindle controller 96 of the disc drive 8. Specifically, the DSP 73 controls the output of the laser emitting part 81 through an RF (Radio Frequency) amplifier 88 of the laser emitting part 81, controls the focus controller 92, the thread controller 94, and the tilt motor 86 based on the tracking error signal from the reflection-light receiving part 82, and controls the focus controller 92 based on the focus error signal from the reflection-light receiving part 82. Also, the DSP 73 receives input of a rectangular wave indicating a rotational frequency of the spindle motor 87 from a frequency generator 89 of the spindle motor, and controls the spindle controller 96 based on this rotational frequency.

The microcomputer 74 controls the drive controller 7 overall, and performs processing for changing the disc drive 8 between the “recording” state and the “recording-standby” state in accordance with an instruction from the data controller 6.

The microcomputer 74 performs stop processing of the operation of the DSP 73 and the control of the spindle motor 87 as the processing of changing the disc drive 8 to the “recording-standby” state. When the operation of the DSP 73 is stopped, the operations of the laser emitting part 81, the reflection-light receiving part 82, and the RF amplifier 88 are stopped. Also, the operations of the focus controller 92, the tracking controller 93, the thread controller 94, and the tilt controller 95 are stopped, and thus the operations of the focus motor 83, the tracking motor 84, the thread motor 85, and the tilt motor 86 are stopped.

A switch 75 is provided between the microcomputer 74 and the motor drive 91. The microcomputer 74 controls to change the switch 75 to an A-terminal in the “recording” state, and change the switch 75 to a B-terminal in the “recording-standby” state. When the microcomputer 74 changes the switch 75 to the A-terminal, the microcomputer 74 is connected to the motor drive 91. The microcomputer 74 outputs a control signal to the motor drive 91 to control the spindle motor 87. The microcomputer 74 is connected to the frequency generator 89 of the spindle motor 87. The frequency generator 89 outputs a rectangular wave indicating the number of revolutions of the spindle motor 87. The microcomputer 74 controls the spindle motor 87 while monitoring the rectangular wave output from the frequency generator 89.

In the “recording-standby” state, the four motors, that is to say, the focus motor 83, the tracking motor 84, the thread motor 85, and the tilt motor 86 are stopped. It is possible to reduce power consumption by stopping unnecessary motors in the “recording-standby” state.

Also, at this time, the laser emitting part 81 and the reflection-light receiving part 82 are also stopped. It is possible to reduce power consumption by stopping the laser emitting part 81 and the reflection-light receiving part 82 in the “recording-standby” state.

When having received the instruction to move to the “recording” state from the data controller 6, the microcomputer 74 changes the disc drive 8 to the “recording state”. The microcomputer 74 restarts the operation of the DSP 73 and changes the switch 75 to the B-terminal as the processing for changing to the “recording state”. When the microcomputer 74 has restarted the operation of the DSP 73, the microcomputer 74 controls the output of the laser emitting part 81 through the RF amplifier 88 of the laser emitting part 81, and generates control signals for controlling the focus controller 92, the tracking controller 93, the thread controller 94, the tilt controller 95, and the spindle controller 96 based on the signals from the reflection-light receiving part 82. The microcomputer 74 changes the switches of the focus motor 83, the tracking motor 84, the thread motor 85, and the tilt motor 86 to ON to restart the recording operation. The disc drive 8 records the audio-video data stored in the drive memory 71 onto the optical recording medium under the control of the DSP 73.

When the microcomputer 74 receives the instruction to move to the “recording-standby” state from the data controller 6, the microcomputer 74 changes the disc drive 8 from the “recording” state to the “recording-standby” state. In the “recording-standby” state, the operations other than the operation of the spindle motor 87 are turned OFF in order to reduce the power consumption.

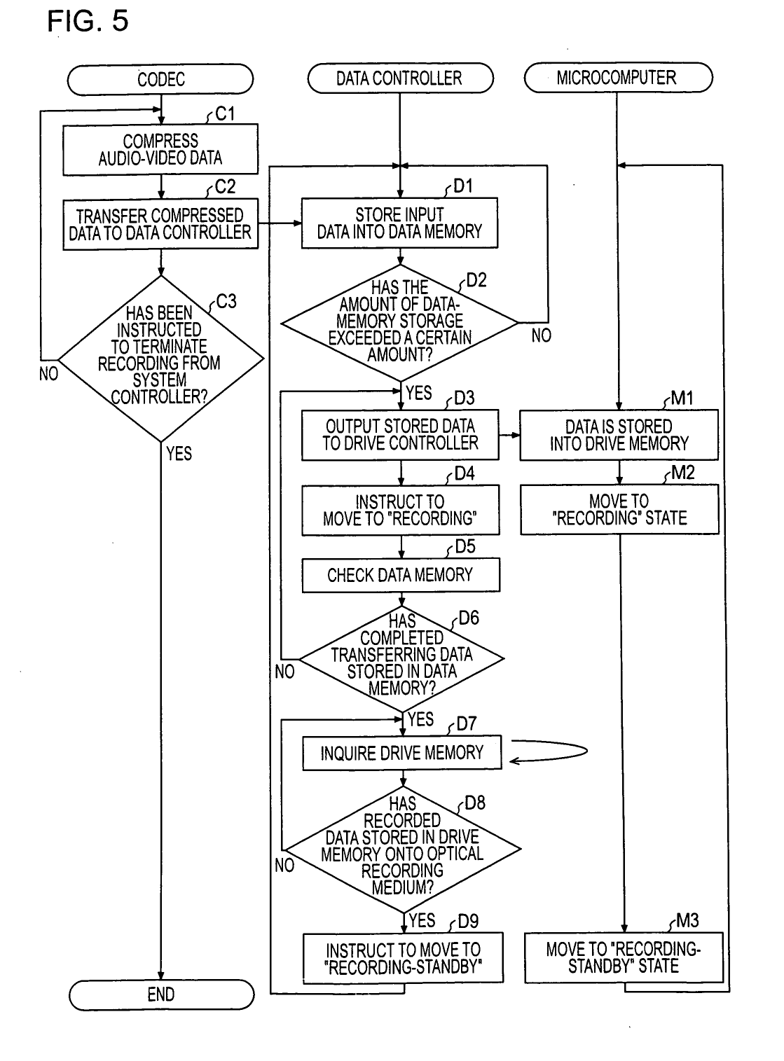

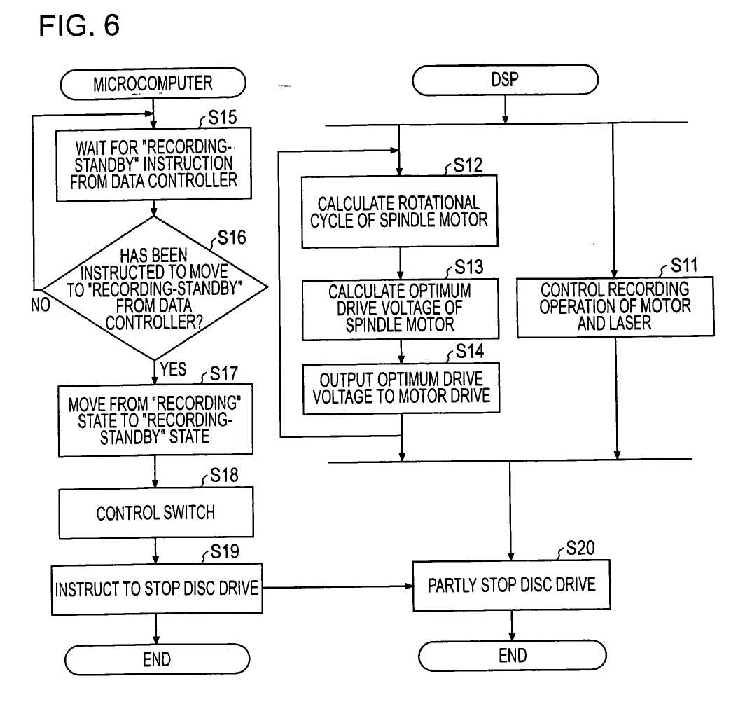

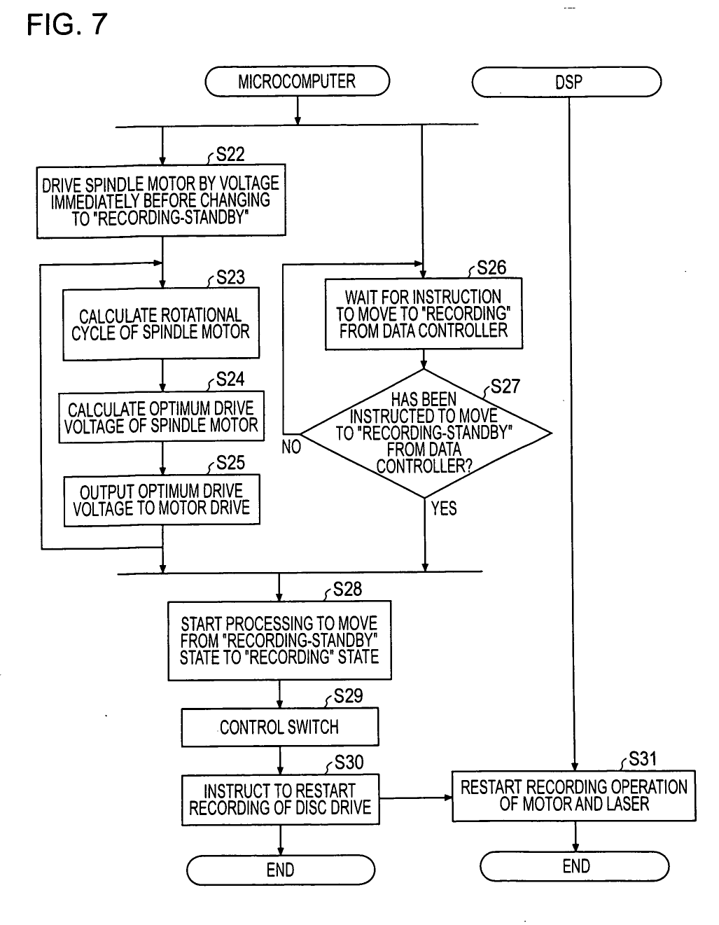

Next, a description will be given of the entire operation of the recording-reproduction apparatus 1 with reference to FIG. 5. A description will be given of the operation of the transition of the disc drive 8 from the “recording” state to the “recording-standby” state with reference to FIG. 6. A description will be given of the operation of the transition of the disc drive 8 from the “recording-standby” state to the “recording” state with reference to FIG. 7.

As shown in FIG. 5, the CODEC 5 compresses the audio-video data input from the camera 11, an external device, etc., (step C1), and outputs the compressed audio-video data to the data controller 6 (step C2). When the CODEC 5 receives the input of a recording-stop instruction from the system controller 3 (step C3; YES), the CODEC 5 terminates the compression processing of the audio-video data. On the other hand, when the CODEC 5 does not receive the input of a recording-stop instruction from the system controller 3 (step C3; NO), the CODEC 5 repeats the processing of step C1 to step C2.

The data controller 6 stores the input audio-video data into the data memory 61 (step D1). The data controller 6 checks the amount of storage of the audio-video data. If the amount of storage exceeds a certain amount (step D2; YES), the data controller 6 outputs the data stored in the data memory 61 into the drive controller 7 (step S3), and instructs the microcomputer 74 to change the disc drive 8 to the “recording” state (step D4).

The microcomputer 74 stores the audio-video data input from the data controller 7 into the drive memory 71 (step M1), and changes the disc drive 8 to the “recording” state (step M2) by receiving the instruction from the data controller 6. On the other hand, when the amount of the storage in the data memory 61 does not exceed a certain amount (step D2; NO), the data controller 6 instructs the microcomputer 74 to change the disc drive 8 to the “recording-standby” state (step D4), and the microcomputer 74 changes the disc drive 8 to the “recording-standby” state by receiving the instruction (step M3).

The data controller 6 also checks the data memory 61 in the “recording” state (step D5). If it is confirmed that all the audio-video data stored in the data memory 61 has been transferred to the drive controller 7 (step D6; YES), an inquiry is conducted subsequently on whether all the data transferred to the drive memory 71 has been recorded onto the optical recording medium (step D7). If that confirmation is made (step D8; YES), the data controller 6 instructs the microcomputer 74 to change the disc drive 8 to the “recording-standby” state (step D9). The microcomputer 74 receives the instruction, and changes the disc drive 8 to the “recording-standby” state (step M3). If the audio-video data that has not been recorded onto the optical recording medium remains stored in the data memory 61 and the drive memory 71 (step D6; NO, D8; NO), the “recording” state is kept.

The flowchart in FIG. 6 illustrates the operation of the microcomputer 74 and the DSP 73 when the processing moves from the “recording operation” state to the “wait recording” state. In the “recording” state, the DSP 73 controls all of the laser emitting part 81, the reflection-light receiving part 82, the focus motor 83, the tracking motor 84, the thread motor 85, the tilt motor 86, and the spindle motor 87 of the disc drive 8, and records the data onto the optical recording medium (step S11).

The DSP 73 receives the input of the rectangular wave in accordance with the number of rotations of the spindle motor 87 from the frequency generator 89 of the spindle motor 87. The DSP 73 counts the edges of the rectangular wave by an edge-counting function to calculate the rotational cycle of the spindle motor 87 (step S12). The DSP 73 calculates the optimum drive voltage of the spindle motor 87 based on the calculated rotational cycle (step S13), and outputs the voltage to the motor drive 91 (step S14).

The microcomputer 74 waits for the instruction from the data controller 6 to move to the “recording-standby” state while the DSP 73 is recording the data onto the optical recording medium (step S15). When the microcomputer 74 receives the instruction from the data controller 6 to move from the “recording” state to the “recording-standby” state (step S16; YES), the microcomputer 74 starts the processing to change the disc drive 8 from the “recording” state to the “recording-standby” state (step S17). On the other hand, if the microcomputer 74 does not receive the instruction from the data controller 6 in step S15 (step S16; NO), the microcomputer 74 continues to wait for the instruction from the data controller 6.

For the processing to move to the “recording-standby” state, the microcomputer 74 controls the switch 75 to connect the motor drive 91 and the microcomputer 74 (step S18), and stops the focus motor 83, the tracking motor 84, the thread motor 85, the tilt motor 86, the RF amplifier 88, the laser emitting part 81, the reflection-light receiving part 82, and the DSP 73 (step S19). Thus, the recording operation of the DSP 73 is stopped (step S20), and the control of the spindle motor is changed from the DSP 73 to the microcomputer 74.

FIG. 7 is a flowchart illustrating the operation of the microcomputer 74 and the DSP 73 when the processing moves from the “wait recording” state to the “recording operation” state. In the “recording-standby” state, the microcomputer 74 controls the spindle motor 87. The microcomputer 74 starts supplying voltage to the spindle motor 87 using the optimum drive voltage immediately before changing to the “recording-standby” state as an initial value (step S22). For the supply source of the voltage, a method of smoothing the output of PWM (Pulse Width Modulation) contained in the microcomputer 74 and using it is considered. Next, the microcomputer 74 receives the input of the rectangular wave in accordance with the number of rotations of the spindle motor 87 from the frequency generator 89 of the spindle motor 87. The microcomputer 74 counts the edges of the rectangular wave to calculate the rotational cycle of the spindle motor 87 (step S23). The microcomputer 74 calculates the optimum drive voltage of the spindle motor 87 based on the calculated rotational cycle (step S24), and supplies the optimum voltage to the spindle motor 87 (step S25).

The microcomputer 74 waits for the instruction to move to the “recording” state from the data controller 6 during the “recording-standby” state (step S26). When the microcomputer 74 receives the instruction to move to the “recording” state (step S27; YES), the microcomputer 74 starts the processing to move the disc drive 8 from the “recording-standby” state to the “recording” state (step S28). For the processing to move to the “recording” state, the microcomputer 74 controls the switch 75 to connect the motor drive 91 and the DSP 73 (step S29), and outputs the control signal to the DSP 73 and the motor drive 91 (step S30). The DSP 73 returns itself from the stop state in response to the control signal from the microcomputer 74, and restarts the recording operation of the motor drive 91, the focus motor 83, the tracking motor 84, the tilt motor 86, the RF amplifier 88, the laser emitting part 81, and the reflection-light receiving part 82 (step S31).

As described above, the recording-reproduction apparatus 1 to which the present invention is applied performs intermittent recording in which the “recording” state and the “recording-standby” state are alternately repeated. During the “recording-standby” state, the operations other than the operation of the spindle motor 87 are stopped, and thus power consumption is reduced. Also, the control of the spindle motor 87 is performed by the microcomputer 74, and thus it is possible to keep the spindle motor 87 to run at an appropriate number of rotations even if the load on the spindle motor 87 temporarily changes due to impact, vibration, force of inertia, etc.

Next, a description will be given of the reproduction processing. The recording-reproduction apparatus 1 performs intermittent reproduction. In the intermittent reproduction, a “reading” state and a “reading-standby” state of an optical recording medium are repeated alternately. In the “reading-standby” state, the recording-reproduction apparatus 1 performs processing to reduce power consumption in the same manner as in the “recording-standby” state.

A description will be given of the operations to the CODEC 5, the data controller 6, and the drive controller 7 at reproduction time. The DSP 73 of the drive controller 7 drives the laser emitting part 81 through the RF amplifier 88 to emit laser onto the optical recording medium. The reflection-light receiving part 82 outputs the signal based on the reflection light from the optical recording medium to the DSP 73.

The DSP 73 converts the signal from the reflection-light receiving part 82 into digital data. This data is compressed audio-video data. The DSP 73 stores this data into the drive memory 71. The microcomputer 74 transfers the audio-video data stored in the drive memory 71 to the data controller 6. The data controller 6 stores the audio-video data input from the drive controller 7 into the data memory 61. The CODEC 5 reads the compressed audio-video data from the data memory 61, and expands the audio-video data that has been read.

The data controller 6 controls the data flow between the CODEC 5 and the drive controller 7. When the data controller 6 stores a certain amount of the audio-video data read by the drive controller 7, the data controller 6 outputs the control signal to stop the reading of the data to the drive controller 7. While the drive controller 7 stops the reading of the data, the data controller 6 outputs the stored audio-video data to the CODEC 5. While the CODEC 5 is expanding the audio-video data, the disc drive 8 goes into the “reading-standby” state. When the disc drive 8 is in the “reading-standby” state, the microcomputer 74 of the drive controller 7 stops the operation of the DSP 73 and a part of the operation of the motor drive 91, and performs the control of the spindle motor 87 in place of the DSP 73.

When the data controller 6 outputs the audio-video data stored in the data memory 61 to the CODEC 5, the data controller 6 outputs the control signal to restart the reading of the data to the drive controller 7. Thus, the disc drive 8 becomes the “reading” state. The microcomputer 74 of the drive controller 7 restarts the operations of the DSP 73, the laser emitting part 81, a laser receiving part, the focus motor 83, the tracking motor 84, the thread motor 85, the tilt motor 86, the spindle motor 87, and the motor drive 91.

As described above, the recording-reproduction apparatus 1 to which the present invention is applied performs intermittent recording in which the “reading” state and the “reading-standby” state are alternately repeated. During the “reading-standby” state, the operations other than the operation of the spindle motor 87 are stopped, and thus power consumption is reduced. Also, the control of the spindle motor 87 is performed by the microcomputer 74 in the “reading-standby” state, and thus it is possible to keep the spindle motor 87 to run at an appropriate number of rotations even if the load on the spindle motor 87 temporarily changes due to impact, vibration, force of inertia, etc.

It should be understood by those skilled in the art that various modifications, combinations, sub-combinations and alterations may occur depending on design requirements and other factors insofar as they are within the scope of the appended claims or the equivalents thereof.

What is claimed is:

1. A recording apparatus comprising:
recording means having a drive part including rotational drive means for rotating an optical recording medium in order to record data onto the optical recording medium;
data coding means for coding data; and
recording control means for storing the coded data into storage means, and controlling the recording means to record the data stored in the storage means onto the optical recording medium,
wherein the recording control means includes
overall control means for controlling the recording control means overall and
servo control means for servo-controlling the drive part of the recording means, and
in a recording-standby state standing by to store the coded data, the overall control means stops operation of the servo control means, and at the same time, servo-controls the rotational drive means.

2. The recording apparatus according to claim 1,
wherein the overall control means is a microcomputer, and a recording state and a recording-standby state are changed in accordance with a storage state of the coded data.

3. The recording apparatus according to claim 1,
wherein the overall control means applies a voltage for setting a rotational frequency of the rotational drive means to a target rotational frequency by feeding back the rotational frequency of the rotational drive means.

4. A method of controlling a recording apparatus having a drive part including rotational drive means for rotating an optical recording medium in order to record data onto the optical recording medium, the method comprising the steps of:
coding data;
controlling the rotational drive means for storing by overall control means controlling the recording apparatus overall in a recording-standby state to store the coded data; and
servo-controlling the drive part by servo control means for drive-controlling the recording apparatus to record the coded data onto the optical recording medium when storing the coded data is completed.

5. A reproduction apparatus comprising:
reading means having a drive part including rotational drive means for rotating an optical recording medium in order to read coded data recorded in the optical recording medium;
read control means for controlling the reading means;
storing means for storing the read coded data; and
decoding means for decoding the stored coded data,
wherein the read control means includes
overall control means for controlling the read control means overall and
servo control means for servo-controlling the drive part of the reading means, and
in a reading-standby state standing by to decode the coded data stored in the storing means, the overall control means stops operation of the servo control means, and at the same time, controls the rotational drive means.

6. The reproduction apparatus according to claim 5,
wherein the overall control means is a microcomputer, and a reading state and a reading-standby state are changed in accordance with a storage state of the storing means.

7. The reproduction apparatus according to claim 5,
wherein the overall control means applies a voltage for setting a rotational frequency of the rotational drive means to a target rotational frequency by feeding back the rotational frequency of the rotational drive means.

8. A method of controlling a reproduction apparatus having a drive part including rotational drive means for rotating an optical recording medium in order to read coded data recorded onto the optical recording medium, the method comprising the steps of:
reading coded data recorded in the optical recording medium of the reproduction apparatus;
storing the read coded data into the storing means; and
controlling the rotational drive of the optical recording medium by overall control means controlling the reproduction apparatus overall in a reading-standby state standing by to decode the coded data stored in the storing means.

9. A recording apparatus comprising:
a recording mechanism having a drive part including a rotational drive for rotating an optical recording medium in order to record data onto the optical recording medium;
a data coder coding data; and
a recording controller storing the coded data into a storage device, and controlling the recording mechanism to record the data stored in the storage device onto the optical recording mechanism,
wherein the recording controller includes
an overall controller controlling the recording controller overall and
a servo controller servo-controlling the drive part of the recording mechanism, and
in a recording-standby state standing by to store the coded data, the overall controller stops operation of the servo controller, and at the same time, servo-controls the rotational drive.

10. A reproduction apparatus comprising:
a reading mechanism having a drive part including a rotational drive for rotating an optical recording medium in order to read coded data recorded in the optical recording medium;
a read controller controlling the reading means;
a storing device storing the read coded data; and
a decoder decoding the stored coded data,
wherein the read controller includes
an overall controller controlling the read controller overall and
servo controller servo-controlling the drive part of the reading mechanism, and
in a reading-standby state standing by to decode the coded data stored in the storing device, the overall controller stops operation of the servo controller, and at the same time, controls the rotational drive.
